(19) United States
(12) Patent Application Publication
(10) Pub. No.: US 2026/0337344 A1
(43) Pub. Date: Oct. 29, 2026

(54) METHOD FOR PRODUCING SIOC-LINKED, LINEAR POLYDIALKYLSILOXANE-POLYETHER BLOCK COPOLYMERS AND THE USE THEREOF

(71) Applicant: Evonik Operations GmbH, Essen (DE)

(72) Inventors: Matthias LOBERT, Essen (DE); Thomas REIBOLD, Herten (DE); Jörg DIENDORF, Essen (DE); Sven GAHRENS, Essen (DE); Ursula SKRZYPCZYK, Herne (DE)

(73) Assignee: Evonik Operations GmbH, Essen (DE)

(21) Appl. No.: 19/115,025

(22) PCT Filed: Sep. 13, 2023
(86) PCT No.: PCT/EP2023/075079

§ 371 Date: Mar. 25, 2025

(30) Foreign Application Priority Data
Sep. 28, 2022 (EP) 22198360.4

(51) Int. Cl. C08G 77/46; C08G 77/00; C08J 9/00; C08L 75/08

(52) U.S. Cl. CPC C08G 77/46; C08J 9/0061; C08L 75/08; C08G 77/70; C08J 2375/08; C08J 2483/12; C08L 2203/14

(57) ABSTRACT

The invention relates to a method for producing SiOC-linked, linear polydialkylsiloxane-polyoxyalkylene block copolymers having repeating (AB) units, comprising the reaction of a linear, α,ω—(SiH)-functional polydialkylsiloxane (a) with a linear, α,ω—(OH)-functional polyoxyalkylene (b), using one or more compounds of elements of the third main group and/or third subgroup as catalyst (c), the two reactants (a) and (b) being preferably reacted in equimolar amounts and with controlled hydrogen formation until quantitative SiH conversion.

The present invention is in the fields of silicone chemistry and polyurethane chemistry and relates to a process for producing SiOC-bonded, linear polydialkylsiloxane-polyoxyalkylene block copolymers comprising repeating (AB) units and to the use thereof in the production of polyurethanes (PU for short).

The principle of the process for producing SiOC-bonded polydialkylsiloxy-polyoxyalkylene block copolymers by reaction of SiH-functional polyorganosiloxanes with alcohols/OH-functional polyoxyalkylene polymers using one or more compounds of elements of main group III and/or the 3rd transition group as catalyst is known in principle from EP 1460099 B1. Described therein is a preferred reaction of an at least equimolar to 3-fold excess of alcohol groups to SiH groups. This process was used to react linear and/or branched polyorganosiloxanes with alcohols and/or OH-functional polyoxyalkylenes.

A process for producing SiOC-bonded, linear polydimethylsiloxane-polyether block copolymers comprising repeating (AB) units is also known from EP 1935922 B1, wherein the thus-produced polydimethylsiloxane-polyoxyalkylene block copolymers are used as interface-active additives for producing polyurethane foams. EP 1935922 B1 describes the reaction of linear α,ω—(SiH)-functional polydimethylsiloxanes comprising linear α,ω—(OH)-functional polyether diols using one or more compound of elements of main group III and/or the 3rd transition group as catalyst. This process which may be performed neat or in the presence of solvent has the essential feature that the (SiH) functions of the polydimethylsiloxanes relative to the (OH) functions of the polyoxyalkylene are used in a molar excess of preferably 1.1 to 2.0 and the reaction is continued until (SiH) groups can no longer be detected by gas volumetric means.

However, the use in excess of the polysiloxane which is much more costly than the polyether diol component and the subsequent lengthy postreaction for quantitative reaction of the excess (SiH) groups is disadvantageous from an economic standpoint.

It was accordingly an object of the present invention to provide a simple, economically viable and stable process which makes it possible to produce SiOC-bonded, linear polydialkylsiloxane-polyoxyalkylene block copolymers comprising repeating (AB) units reproducibly and with an improved profile of properties, preferably with a focus on using them as interface-active additives for production of polyurethane foams, especially for production of rigid polyurethane foams.

It has now been found that, surprisingly, the use of preferably equimolar amounts of (SiH) functions of a linear, α,ω—(SiH)-functional polydiorganosiloxane relative to the (OH) functions of a linear α,ω—(OH)-functional polyoxyalkylene in conjunction with controlled hydrogen evolution as per claim 1 makes it possible to provide particularly high molecular weight products which represent qualitatively higher quality products than those obtainable by the process published in EP 1935922 B1. Controlled evolution of hydrogen may be brought about through controlled dosage. The process according to the invention is moreover markedly more stable and less prone to failure.

The invention provides a process for producing SiOC-bonded, linear polydialkylsiloxane-polyoxyalkylene block copolymers comprising repeating (AB) units, comprising the reaction of a linear, α,ω—(SiH)-functional polydialkylsiloxane (a) with a linear α,ω—(OH)-functional polyoxyalkylene (b) using one or more compounds of elements of main group III and/or the 3rd transition group as catalyst (c), optionally in the presence of a solvent (d), wherein the two reactants (a) and (b) are reacted preferably in equimolar amounts and with controlled evolution of hydrogen until SiH conversion is quantitative.

Reactant (a) in the context of the present invention is: linear α,ω—(SiH)-functional polydialkylsiloxane.

Reactant (b) in the context of the present invention is: linear α,ω—(OH)-functional polyoxyalkylene.

In a particularly preferred embodiment of the invention, the linear α,ω—(SiH)-functional polydialkylsiloxane used in the process according to the invention has SiH values between 0.25 and 3.0 mol/kg, more preferably between 0.5 and 2.0 mol/kg, especially between 0.75 and 1.5 mol/kg. The determining of the molar amount of SiH units of the linear α,ω—(SiH)-functional polydialkylsiloxanes is based here on the known method of alkali-catalysed SiH value determination.

The invention further provides the SiOC-bonded, linear polydialkylsiloxane-polyether block copolymers comprising repeating (AB) units, produced by the process according to the invention.

The expressions “SiOC-bonded, linear polydialkylsiloxane-polyether block copolymers” and “SiOC-bonded, linear polydialkylsiloxane-polyoxyalkylene block copolymers” are used synonymously in the context of this invention.

The invention further provides for the use of the SiOC-bonded, linear polydialkylsiloxane-polyether block copolymers comprising repeating (AB) units that are produced by the process according to the invention as interface-active additives, especially as cell openers, for production of polyurethane foams (PU foams), preferably of rigid polyurethane foams, especially of rigid polyurethane foams with a high open cell content. A particularly preferred rigid polyurethane foam is one-component canned PU foam (building foam, assembly foam, one-component foam/OCF). Especially preferred are rigid polyurethane foams where a high cell content is advantageous, for example open-cell spray foam, packaging foam, headliner foam, pipe insulation foam, flower foam and/or thermoformable rigid foams etc.

The invention further provides a polyurethane foam, preferably rigid polyurethane foam, especially a rigid polyurethane foam with high open cell content, produced using SiOC-bonded, linear polydialkylsiloxane-polyether block copolymers comprising repeating (AB) units according to the invention.

The invention further provides for use of the polyurethane foam according to the invention, preferably rigid polyurethane foam, especially rigid polyurethane foam with high open cell content, for production of foam mouldings, spray foam, insulation foam, sealing compounds, bonding compounds, insulating compounds, assembly compounds and/or filling compounds.

### BRIEF DESCRIPTION OF FIGURES FIG. 1 TO FIG. 6

FIG. 1 shows the progression of the gas volume liberated through the progress of the reaction as a function of the added siloxane mass for Example 1 from the Experimental, in each case as the target and actual conversion.

FIG. 2 shows the progression of the gas volume liberated through the progress of the reaction as a function of the added siloxane mass for Example 2 from the Experimental, in each case as the target and actual conversion.

FIG. 3 shows the progression of the gas volume liberated through the progress of the reaction as a function of the added siloxane mass for Example 3 from the Experimental, in each case as the target and actual conversion.

FIG. 4 shows the progression of the gas volume liberated through the progress of the reaction as a function of the added siloxane mass for Example 4 from the Experimental, in each case as the target and actual conversion.

FIG. 5 shows the progression of the gas volume liberated through the progress of the reaction as a function of the added siloxane mass for Example 5 from the Experimental, in each case as the target and actual conversion.

FIG. 6 shows the difference between the target and actual conversion in % as a function of the added siloxane mass for Examples 1 to 5 from the Experimental.

The linear α,ω—(SiH)-functional polydialkylsiloxanes used in the process according to the invention are known per se. They may be subjected to (preferably acidic) equilibration in known fashion by any desired prior art process.

They preferably have weight average molecular weights between about 650 and 7000 g/mol, preferably between 1000 and 6000 g/mol, in particular between about 1500 to 4500 g/mol. This corresponds to a preferred embodiment of the invention. The determination of the average molecular weights is based on the known methods of GPC analysis.

It is preferable to use linear α,ω—(SiH)-functional polydialkylsiloxanes of general formula (I):

M′-Dₐ-M′ Formula (I)
where
M′=[HR₂¹SiO_{1/2}]
D=[R₂¹SiO_{2/2}]
a=8-100, preferably 10-60, more preferably 20-50,
R¹=independently at each occurrence identical or different hydrocarbon radicals having 1-20 carbon atoms, preferably methyl, ethyl, propyl or butyl, especially preferably methyl.

The linear α,ω—(OH)-functional polyoxyalkylenes (hereinbelow for the purposes of the present invention also referred to simply as “polyether diols”) are likewise known per se.

They may be produced by any desired prior art process. They preferably conform to general formula (II):

HO—(CₙH(₂ₙ₋ₘ)R²ₘO—)_{b}-H Formula (II)
b=1-200, preferably 10-100, especially preferably 25-60,
n=2-4,
m=0 or 1,
R²=independently at each occurrence identical or different hydrocarbon radicals having 1-12 carbon atoms, preferably methyl, ethyl, propyl or butyl, especially preferably methyl or ethyl.

It is preferable when the polyether diols are addition products of at least one alkylene oxide selected from the group of ethylene oxide, propylene oxide, butylene oxide, dodecene oxide and/or tetrahydrofuran onto difunctional starters such as for example water, ethylene glycol or propylene glycol.

The polyether diols are preferably constructed from at least two monomer units, especially preferably from ethylene oxide and propylene oxide.

The polyether diols preferably consists substantially of oxyethylene units or oxypropylene units, preference being given to mixed oxyethylene and oxypropylene units having an oxyethylene proportion of about 25% to 70% by weight and an oxypropylene proportion of 70% to 25% by weight based on the total content of oxyalkylene units in the block.

The oxyethylene units or oxypropylene units may thus have a random or blockwise construction, preferably a blockwise construction.

The weight-average molecular weight Mw of each polyether diol is preferably between about 600 and 10 000 g/mol, preferably 1000 to 5000 g/mol, especially preferably 1500 to 3500 g/mol. Determination of average molecular weights is based on the known methods of OH number determination.

The molar ratio of linear α,ω—(SiH)-functional polydialkylsiloxane to linear α,ω—(OH)-functional polyoxyalkylene used with preference in the process according to the invention is in the equimolar range. This means the use of preferably equimolar amounts of (SiH)-functions of the linear, α,ω—(SiH)-functional polydialkylsiloxane relative to the (OH)-functions of the linear α,ω—(OH)-functional polyoxyalkylene.

When reference is made in the context of the present invention to equimolar ratios or equimolar amounts of the two reactants (a) and (b), this in the context of the present invention very specifically encompasses the range from 0.9 to 1.10, preferably 0.98 to 1.02, of α,ω—(SiH)-functional polydialkylsiloxane to linear α,ω—(OH)-functional polyoxyalkylene. This ratio is in particular very precisely equimolar, i.e. 1 to 1.

The total siloxane block content (A) in the SiOC-bonded, linear polydialkylsiloxane-polyoxyalkylene block copolymer having repeating (AB) units is preferably between 20% and 60% by weight, in particular 40% to 50% by weight, and the proportion of polyoxyalkylene blocks (B) is preferably between 80% and 40% by weight, preferably 60% to 50% by weight. It is preferable when the block copolymer has an average weight-average molecular weight Mw of at least 10 000 g/mol to about 250 000 g/mol, preferably 15 000 g/mol to about 225 000 g/mol, in particular 20 000 g/mol to about 200 000 g/mol. The determination of the average molar masses is based on the known methods of GPC analysis.

Depending on the application and desired product properties the process may be performed in the presence or absence of solvent as desired.

If particularly high molecular weight and thus particularly high viscosity SiOC-bonded copolymers are produced the use of a solvent is particularly advantageous.

Advantageously usable solvents are for example alkanes, isoalkanes, cycloalkanes and/or alkylaromatics.

Advantageously usable alkanes are for example n-hexane, n-heptane, n-octane, n-nonane, n-decane, n-undecane and/or n-dodecane.

Advantageously usable cycloalkanes are for example cyclohexane, methylcyclohexane, cycloheptane, cyclooctane, cyclononane, cyclodecane, cycloundecane, cyclododecane and/or decalin.

Advantageously usable alkylaromatics are toluene, xylene, cumene, n-propylbenzene, ethylmethylbenzene, trimethylbenzene, solvent naphtha and/or any alkylbenzenes available on a large industrial scale.

High-boiling solvents usable with preference are those having boiling points >120 °C, especially preferably high-boiling alkylbenzenes.

The choice and amount of the optional solvent depends on the specific application and may be varied over wide ranges.

For the purposes of particularly good product quality and particularly good efficiency in the context of a preferred embodiment of the invention it is preferable to use between 40% by weight and 75% by weight of solvent based on the sum of the amounts of the reactants (a), (b) and the amount of solvent (c), especially preferably between 55% by weight and 65% by weight.

In the context of a preferred embodiment the reaction temperature for producing the block copolymers according to the invention is preferably 60 °C to 140 °C, especially preferably 100 °C to 120 °C.

The catalysts preferably usable in the process according to the invention in the context of a preferred embodiment of the invention are Lewis-acidic compounds of elements of main group III, in particular boron-containing and/or aluminium-containing compounds of elements.

Preferred Lewis-acidic compounds of elements of the 3rd transition group are especially scandium-containing, yttrium-containing, lanthanum-containing and/or lanthanoid-containing Lewis acids. The element compounds of main group III and/or the 3rd transition group may more preferably be used in the form of halides, alkyl compounds, fluorinated, cycloaliphatic and/or heterocyclic compounds.

A preferred embodiment of the invention provides that fluorinated and/or unfluorinated organoboron compounds are used as catalysts, especially those selected from (C₅F₄)(C₆F₅)₂B; (C₅F₄)₃B; (C₆F₅)BF₂; BF(C₆F₅)₂; B(C₆F₅)₃; BCl₂(C₆F₅); BCl(C₆F₅)₂; B(C₆H₅)(C₆F₅)₂; B(Ph)₂(C₆F₅); [C₆H₄(mCF₃)]₃B; [C₆H₄(pOCF₃)]₃B; (C₆F₅)B(OH)₂; (C₆F₅)₂BOH; (C₆F₅)₂BH; (C₆F₅)BH₂; (C₇H₁₁)B(C₆F₅)₂; (C₈H₁₄B)(C₆F₅); (C₆F₅)₂B(OC₂H₅); (C₆F₅)₂B—CH₂CH₂Si(CH₃)₃;

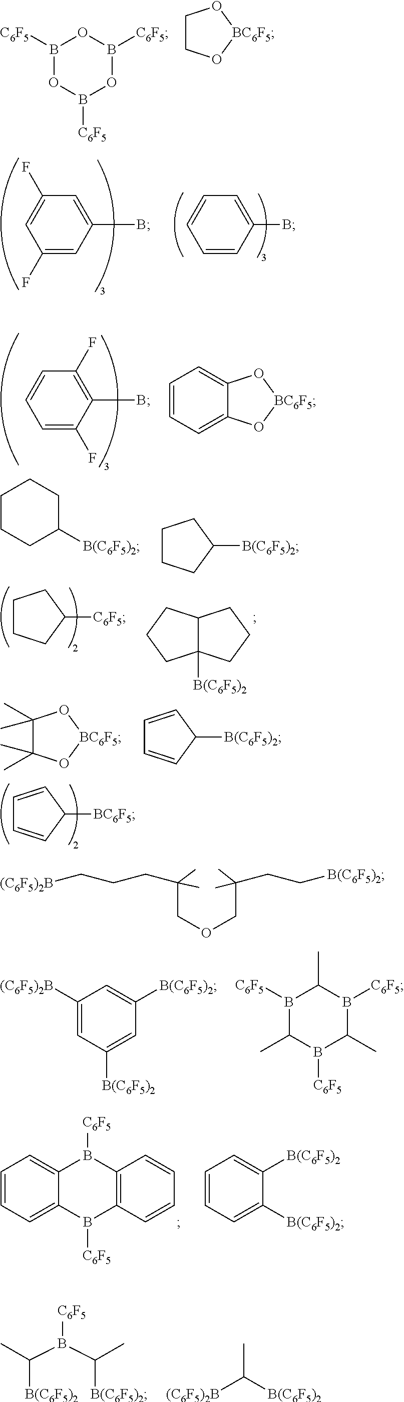

especially tris(perfluortriphenylborane) [1109-15-5], boron trifluoride etherate [109-63-7], borane triphenylphosphine complex [2049-55-0], triphenylborane [960-71-4], triethylborane [97-94-9] and boron trichloride [10294-34-5], tris(pentafluorophenyl) boroxine (9Cl) [223440-98-0], 4,4,5,5,-tetramethyl-2-(pentafluorophenyl)-1,3,2-dioxaborolane (9Cl) [325142-81-2], 2-(pentafluorophenyl)-1,3,2-dioxaborolane (9Cl) [336880-93-4], bis(pentafluorophenyl)cyclohexylborane yl(pentafluorophenyl)borane (9Cl) [336881 Mar. 9], (hexahydro-3a (1H)-[245043-30-5], di-2,4-cyclopentadien-1-pentalenyl)bis(pentafluorophenyl)borane (9Cl) [336880-98-9], 1,3-[2-[bis(pentafluorophenyl) boryl]ethyl]tetramethyldisiloxane [336880-99-0], 2,4,6-tris(pentafluorophenyl) borazine (7Cl, 8Cl, 9Cl) [1110-39-0], 1,2-dihydro-2-(pentafluorophenyl)-1,2-azaborine (9Cl) [336880-94-5], 2-(pentafluorophenyl)-1,3,2-benzodioxaborole (9Cl) [336880-96-7], tris(4-trifluoromethoxyphenyl)borane [336880-95-6], tris(3-trifluoromethylphenyl)borane [24455-00-3], tris(4-fluorophenyl)borane [47196-74-7], tris(2,6-difluorophenyl)borane [146355 Sep. 1], tris(3,5-difluorophenyl)borane [154735 Sep. 8], methyliumtriphenyltetrakis(pentafluorophenyl) borate [136040-19-2] and/or N,N-dimethylaniliniumtetrakis(pentafluorophenyl) borate and mixtures of the abovementioned catalysts may be used with preference.

In a further preferred embodiment of the invention, fluorinated and/or unfluorinated organoaluminium compounds are used as catalysts, especially those selected from:

AlCl₃ [7446-70-0], aluminium acetylacetonate [13963-57-0], AlF₃ [7784-18-1], aluminium trifluoromethanesulfonate [74974-61-1], di-iso-butylaluminium chloride [1779-25-5], di-iso-butylaluminium hydride [1191-15-7] and/or triethylaluminium [97-93-8] and mixtures thereof.

In a further preferred embodiment of the invention, fluorinated and/or unfluorinated organoscandium compounds are used as catalysts, especially those selected from:

scandium(III) chloride [10361-84-9], scandium(III) fluoride [13709-47-2], scandium(III) hexafluoroacetylacetonate [18990-42-6], scandium(III) trifluoromethanesulfonate [144026-79-9] and/or tris(cyclopentadienyl) scandium [1298-54-0] and mixtures thereof.

In a further preferred embodiment of the invention, fluorinated and/or unfluorinated organoyttrium compounds are used as catalysts, especially those selected from: tris(cyclopentadienyl) yttrium [1294 Jul. 1], yttrium(III) chloride [10361-92-9], yttrium(III) fluoride [13709-49-4], yttrium(III) hexafluoroacetylacetonate [18911-76-7] and/or yttrium(III) naphthenate [61790-20-3] and mixtures thereof.

In a further preferred embodiment of the invention, fluorinated and/or unfluorinated organolanthanum compounds are used as catalysts, especially those selected from:

lanthanum (III) chloride [10099-58-8], lanthanum (III) fluoride [13709-38-1], lanthanum (III) iodide [13813-22-4], lanthanum (III) trifluoromethanesulfonate [52093-26-2] and/or tris(cyclopentadienyl) lanthanum [1272-23-7] and mixtures thereof.

In a further preferred embodiment of the invention, fluorinated and/or unfluorinated organolanthanoid compounds are used as catalysts, especially those selected from:

cerium(III) bromide [14457-87-5], cerium(III) chloride [7790-86-5], cerium(III) fluoride [7758-88-5], cerium(IV) fluoride [60627-09-0], cerium(III) trifluoroacetylacetonate [18078-37-0], tris(cyclopentadienyl) cerium [1298-53-9], europium(III) fluoride [13765-25-8], europium(II) chloride [13769-20-5], praesodymium(III) hexafluoroacetylacetonate [47814-20-0], praesodymium(III) fluoride [13709-46-1], praesodymium(III) trifluoroacetylacetonate [59991-56-9], samarium(III) chloride [10361-82-7], samarium(III) fluoride [13765-24-7], samarium(III) naphthenate [61790-20-3], samarium(III) trifluoroacetylacetonate [23301-82-8], ytterbium(III) fluoride [13760-80-8], ytterbium(III) trifluoromethanesulfonate [54761 Apr. 5] and/or tris(cyclopentadienyl) ytterbium [1295-20-1] and mixtures thereof.

The catalysts are preferably used in amounts of 0.01% to about 0.2% by weight, in particular 0.03% to 0.10% by weight, based on the sum of the amount of the reactants (a) and (b).

The catalyst(s) may be used in homogeneous form or in the form of heterogeneous catalyst(s). The catalyst(s) may be added in dissolved or suspended form. The catalyst may advantageously be suspended or dissolved in a small portion of the solvent or the polyether diol and added, especially preferably may be added dissolved in the solvent.

In a preferred embodiment of the process according to the invention the polyether diol is initially charged and dried under vacuum at elevated temperature, optionally in the presence of the solvent, to inhibit the potential side reaction of Si—H to Si—OH in the presence of water. This may be effected for example by vacuum distillation. Dehydrogenative coupling may be favoured by establishing a weakly acidic medium. In order to make the alcohol to be converted weakly acidic it is possible to add diammonium phosphate (DAP; 100 to 500 ppm) before, during or after distillation.

In a preferred embodiment of the process according to the invention the preferably dried polyether diol (reactant (b)) is heated to reaction temperature and the catalyst added and commixed. Then the linear α,ω—(SiH)-functional polydialkylsiloxane (reactant (a)) is added with controlled evolution of hydrogen.

In a preferred embodiment of the process according to the invention the preferably dried polyether diol (reactant (b)) is heated to reaction temperature and the catalyst added and commixed. The siloxane (reactant (a)), diluted with a solvent, is added with controlled evolution of hydrogen.

In a preferred embodiment of the process according to the invention the preferably dried polyether diol (reactant (b)) is heated to reaction temperature, diluted with solvents and the catalyst added and commixed. The siloxane (reactant (a)) is added with controlled evolution of hydrogen.

In a preferred embodiment of the process according to the invention the preferably dried polyether diol (reactant (b)) is heated to reaction temperature, diluted with solvents and the catalyst added and commixed. The siloxane (reactant (a)), diluted with a solvent, is added with controlled evolution of hydrogen.

For these four abovementioned preferred embodiments the following applies: Addition is preferably effected continuously, thus allowing controlled reaction progress as indicated by corresponding continuous gas liberation. Once gas liberation is complete the reaction is complete as demonstrable by external SiH value determination.

In another preferred embodiment the addition of the pure or solvent-diluted siloxane (reactant (a)) in the abovementioned four embodiments may also be performed in intervals rather than continuously. The siloxane (reactant (a)) is thus added in intervals. This means that every addition interval is followed by a pause in addition which advantageously lasts until a lack of evolution of hydrogen indicates quantitative SiH conversion of the previously added portion. This is followed by the addition of the next interval. It is preferable when the addition amount and the times per interval are kept constant but those skilled in the art are able to make adjustments in specific applications. Thus initially larger amounts of siloxane may be added per interval at the beginning of the synthesis and smaller amounts towards the end or vice versa.

It always highly advantageous to ensure efficient commixing during addition.

According to the invention, the reaction of the reactants (a) and (b) proceeds with controlled evolution of hydrogen until SiH conversion is quantitative. In the context of the present invention this is to be understood as meaning that the difference between the actual conversion and the target conversion is as low as possible, preferably in the range from 0% to 10%, preferably from 0% to 7.5% and more preferably from 0% to 5%. The term target conversion is to be understood as meaning the amount of hydrogen that may be liberated upon quantitative SiH conversion of the amount of hydrogensiloxane present in the reaction system at the particular time. The term actual conversion is to be understood as meaning the amount of hydrogen actually liberated at the particular time. This controlled evolution of hydrogen may be achieved through controlled addition of component (a) to component (b). If the variance between the target and actual conversion is excessively high, for example, the rate of addition of component (a) may be throttled. A preferred method for controlling the hydrogen evolution is described in detail in the examples.

The SiOC-bonded, linear polydialkylsiloxane-polyoxyalkylene block copolymers having repeating (AB) units, produced by the process according to the invention, may particularly advantageous to be used as interface-active additives, especially as cell openers, for production of polyurethanes, preferably polyurethane foams, especially for production of rigid polyurethane foams; particular preference is given to one-component canned PU foam (building foam, assembly foam, one-component foam/OCF) and/or other rigid polyurethane foams where high open-cell content is advantageous (for example open-cell spray foam, packaging foam, headliner foam, pipe insulation foams, flower foam and/or thermoformable rigid foams etc.). These uses likewise form part of the subject-matter of the present invention.

For the aforementioned preferred applications, it is particularly desirable that the finished PU foam, preferably rigid PU foam, shows a small change in geometric dimensions during and especially after the curing process. This desirable dimensional stability, i.e. low shrinkage although post-expansion, can preferably be achieved as a result of a high open-cell content of the foam. At the same time, it is desirable that the PU foam, as a result of this open-cell content, however, does not have any major foam defects in the form of cavities: the foam cells should preferably still be fine and not have any coarsening.

For that reason, it may be advantageous in the production of such PU foams to use polyol-isocyanate prepolymer. In particular, however, it is advantageous to add not only the foam stabilizer which is typically present (usually a polyethersiloxane), but also a cell opener, for which application the SiOC-bonded, linear polydialkylsiloxane-polyether block copolymers according to the invention have been found to be very particularly efficient.

The SiOC-bonded, linear polydialkylsiloxane-polyether block copolymers having repeating (AB) units that are obtainable by the process according to the invention can thus be used particularly advantageously as cell openers in the production of polyurethane foams, especially of rigid polyurethane foams.

The term “cell opener” is known per se to the person skilled in the art in connection with the production of PU foams. Cell openers are understood to mean substances that are capable of, or have the function of, causing an elevated open-cell content during the production of a polyurethane foam, preferably rigid polyurethane foam, that would usually otherwise have closed cells for the most part (namely, in the case of rigid PU foam, would have usually less than 30%, preferably less than 20%, more preferably less than 10%, of open cells, based on the total number of cells). The inventive use of the SiOC-bonded, linear polydialkylsiloxane-polyether block copolymers having repeating (AB) units that are obtainable by the process according to the invention as cell openers enables a high open-cell content of the resulting PU foam, especially rigid PU foam. The term “high open-cell content” is defined further down.

The use concentration of the SiOC-bonded, linear polydialkylsiloxane-polyether block copolymers having repeating (AB) units according to the invention as interface-active additive, especially as cell opener, in the polyurethane foam to be produced, preferably rigid polyurethane foam, is preferably between 0.01% by weight and 10% by weight, preferably between 0.05% by weight and 7% by weight, more preferably between 0.1% by weight and 5% by weight, based in each case on the overall formulation of the polyurethane foam.

The term polyurethane foam is known per se to those skilled in the art (see, for example, Adam et al., “Polyurethanes”, Ullmann's Encyclopedia of Industrial Chemistry-Paragraph 7″, 2012, Wiley VCH-Verlag, Weinheim).

A preferred inventive composition of a PU foam, preferably rigid polyurethane foam, contains the following constituents:
a) SiOC-bonded, linear polydialkylsiloxane-polyether block copolymers having repeating (AB) units according to the invention
b) polyol component
c) (poly) isocyanate component
d) catalyst
e) optionally foam stabilizer
f) blowing agent
g) optionally further additives, preferably fillers, liquid or solid flame retardants, dispersing aids etc.

The SiOC-bonded, linear polydialkylsiloxane-polyether block copolymers having repeating (AB) units according to the invention is used here as interface-active additive, preferably as cell opener.

The terms “polyurethane” and “polyurethane foam” are established technical terms which have long been known to those skilled in the art.

Polyurethane (PU) in the context of the present invention is especially understood to mean a product obtainable by reaction of a polyisocyanate component with a polyol component.

In addition to the polyurethane, further functional groups may also be formed in the reaction, for example uretdiones, carbodiimides, isocyanurates, allophanates, biurets, ureas and/or uretonimines. For the purposes of the present invention, therefore, PU is understood as meaning not just polyurethane, but also polyisocyanurates, polyureas, and polyisocyanate reaction products containing uretdione, carbodiimide, allophanate, biuret and/or uretonimine groups.

Accordingly, polyurethane foam (PU foam) in the context of the present invention is understood to mean a foam which is obtained as a reaction product of a polyisocyanate component and a polyol component. In addition to the eponymous polyurethane, further functional groups may be formed here as well, examples being allophanates, biurets, ureas, carbodiimides, uretdiones, isocyanurates or uretonimines.

Rigid PU foam (rigid polyurethane foam) is an established technical term. The known and fundamental difference between flexible foam and rigid foam is that flexible foam shows elastic characteristics and hence deformation is reversible. By contrast, rigid foam is permanently deformed. Further details regarding rigid polyurethane foams can also be found in “Kunststoffhandbuch, Band 7, Polyurethane [Plastics Handbook, volume 7, Polyurethanes]”, Carl Hanser Verlag, 3rd Edition 1993, Chapter 6. The terms “foam” and “foam material” are treated synonymously in the context of the present invention. This is then also correspondingly applicable to composite terms based thereon, for example rigid foam or rigid foam material etc.

Particularly preferred PU foams in the context of the present invention are rigid polyurethane foams, such as, in particular, one-component canned foam, open-cell spray foam, packaging foam, headliner foam, pipe insulation foam, floral foam, thermoformable rigid foam and/or further rigid polyurethane foams where a high open-cell content in particular is advantageous.

Polyol components (b) used may be one or more organic compounds having OH groups, SH groups, NH groups and/or NH₂ groups, having a functionality of 1.8 to 8. The polyol component comprises at least one compound having at least two isocyanate-reactive groups selected from OH groups, SH groups, NH groups and/or NH₂ groups, especially OH groups.

A functionality of 1.8, for example, may arise as a result of at least one compound having a relatively high functionality, for example of greater than or equal to 2, being mixed with at least one compound having a functionality of, for example, 1. This may occur in particular when a polyisocyanate component (c) having a functionality of greater than 2 or additional crosslinkers are used as optional additives.

Appropriate compounds which may typically be used when producing PU foams are known to those skilled in the art and for example described in “Kunststoffhandbuch, Band 7, Polyurethane [Plastics Handbook, volume 7, Polyurethanes]”, Carl Hanser Verlag, 3rd Edition 1993, Chapter 3.1. It is customary to use compounds having OH numbers within a range from 10 to 1200 mg KOH/g.

Particularly preferred compounds are all polyether polyols and polyester polyols typically used for production of polyurethane systems, especially polyurethane foams.

In addition, it is possible to use polyether polycarbonate polyols, polyols based on natural oils (natural oil based polyols, NOPs; described in WO 2005/033167, US 2006/0293400, WO 2006/094227, WO 2004/096882, US 2002/0103091, WO 2006/116456, EP 1678232), filled polyols, prepolymer-based polyols and/or recycled polyols.

Recycled polyols are polyols that are obtained from the chemical recycling of polyurethanes, for example by solvolysis, for example glycolysis, hydrolysis, acidolysis or aminolysis. The use of recycled polyols constitutes a particularly preferred embodiment of the invention.

When the polyol component contains polyol-isocyanate prepolymers, this is a preferred embodiment of the invention.

Isocyanate or polyisocyanate components (c) used may generally be one or more polyisocyanates having two or more isocyanate groups. Suitable polyisocyanates for the purposes of the present invention are all organic isocyanates having two or more isocyanate groups, in particular the aliphatic, cycloaliphatic, arylaliphatic and preferably aromatic polyfunctional isocyanates known per se.

Examples that may be mentioned here are alkylene diisocyanates having 4 to 12 carbon atoms in the alkylene radical, for example dodecane 1,12-diisocyanate, 2-ethyltetramethylene 1,4-diisocyanate, 2-methylpentamethylene 1,5-diisocyanate, tetramethylene 1,4-diisocyanate, pentamethylene diisocyanate (PDI) and preferably hexamethylene 1,6-diisocyanate (HMDI), cycloaliphatic diisocyanates such as cyclohexane 1,3- and 1,4-diisocyanate and the corresponding isomer mixtures, methylene dicyclohexyl 4,4′-diisocyanate (H12MDI), isophorone diisocyanate (IPDI), methylcyclohexyl 2,4- and 2,6-diisocyanate and the corresponding isomer mixtures, and preferably aromatic diisocyanates and polyisocyanates such as toluene 2,4- and 2,6-diisocyanate (TDI) and the corresponding isomer mixtures, naphthalene diisocyanate, diethyltoluene diisocyanate, diphenylmethane 4,4′- or 2,2′- or 2,4′-diisocyanate (MDI) and polymethylene polyphenyl polyisocyanate (PMDI, “polymeric MDI”). The organic polyisocyanates may be used individually or in the form of mixtures thereof. It is likewise possible to use corresponding “oligomers” of the diisocyanates, such as the IPDI trimer based on the isocyanurate, biurets or uretdiones. In addition, the use of prepolymers that are especially based on the abovementioned isocyanates is possible. The mixture of MDI and more highly condensed analogues having an average functionality of 2 to 4 which is known as polymeric MDI (also referred to as “crude MDI”) is particularly suitable, as well as the various isomers of TDI in pure form or as isomeric mixture. It is also possible to use isocyanates which have been modified by the incorporation of urethane, uretdione, isocyanurate, allophanate and other groups, known as modified isocyanates. Examples of particularly suitable isocyanates are also detailed for example in EP 1712578, EP 1161474, WO 00/58383, US 2007/0072951, EP 1678232 and WO 2005/085310, which are hereby fully incorporated by reference.

A preferred ratio of polyisocyanate component and polyol component, expressed as the index of the formulation, i.e. as stoichiometric ratio of isocyanate groups to isocyanate-reactive groups (e.g. OH groups, NH groups) multiplied by 100, is in the range from 10 to 1000 and preferably from 40 to 500. An index of 100 represents a molar ratio of reactive groups of 1:1.

Suitable catalysts (d) that are usable for the production of polyurethanes, especially PU foams, are known to the person skilled in the art from the prior art; compounds usable here in the context of the present invention are all of those that catalyse the reaction of isocyanate groups with OH, NH or other isocyanate-reactive groups and/or the reaction of isocyanate groups with one another. It is possible here to use the customary catalysts known from the prior art, including for example amines (cyclic, acyclic; monoamines, diamines, oligomers having one or more amino groups), ammonium compounds, organometallic compounds and/or metal salts, preferably those of tin, iron, bismuth, potassium and/or zinc. In particular, catalysts used may be mixtures of two or more compounds of this kind.

Foam stabilizers (e) and the use thereof in the production of PU foams are known to those skilled in the art. The use of foam stabilizers is optional; preference is given to using one or more foam stabilizers. Foam stabilizers that may be used are in particular surface-active compounds (surfactants). They may be used to optimize the desired cell structure and the foaming process. In the context of the present invention, it is possible in particular to use Si-containing compounds that assist foam production (stabilization, cell regulation, cell opening, etc.). These compounds are sufficiently well known from the prior art. It is more preferably possible to use at least one foam stabilizer based on a polyethersiloxane (polydialkylsiloxane-polyether copolymer). Corresponding siloxane structures usable in the context of this invention are described, for example, in the following patent specifications: CN 103665385, CN 103657518, CN 103055759, CN 103044687, US 2008/0125503, US 2015/0057384, EP 152087 A1, EP 1211279, EP 0867464, EP 0867465, EP 0275563. As well as surface-active Si-containing compounds, Si-free surfactants may also be used. For example, EP2295485 A1 describes the use of lecithin and U.S. Pat. No. 3,746,663 the use of vinylpyrrolidone-based structures as foam stabilizer for the production of rigid PU foam. Further Si-free foam stabilizers are described for example in EP 2511328 B1, DE 1020011007479 A1, DE 3724716 C₁, EP 0734404, EP 1985642, DE 2244350 and U.S. Pat. No. 5,236,961.

Blowing agents and the use thereof in the production of PU foams are known to those skilled in the art. The use of blowing agents is optional; preference is given to using blowing agents. The use of a blowing agent (f) or of a combination of two or more blowing agents (f) depends in principle on the nature of the foaming process used, on the nature of the system and on the use for the PU foam obtained. Chemical and/or physical blowing agents may be used, as well as a combination of the two. Depending on the amount of blowing agent used, a foam having high or low density is produced. For instance, foams can be produced with densities of 3 kg/m³ to 900 kg/m³, preferably 5 to 350 kg/m³, more preferably 8 to 200 kg/m³, especially 8 to 250 kg/m³.

Physical blowing agents that may be used with preference are one or more of the appropriate compounds having suitable boiling points and mixtures thereof, for example hydrocarbons having 3, 4 or 5 carbon atoms, preferably cyclo-, iso-, n-pentane, hydrofluorocarbons (HFCs), preferably HFC 245fa, HFC 134a or HFC 365mfc, hydrochlorofluorocarbons (HCFCs), preferably HCFC 141b, hydrofluoroolefins (HFOs) or hydrohaloolefins, preferably 1234ze, 1234yf, 1224 yd, 1233zd (E) or 1336mzz, esters, preferably methyl formate, ketones, preferably acetone, ethers, preferably dimethoxymethane, or chlorinated hydrocarbons, preferably dichloromethane or 1,2-dichloroethane.

It is likewise preferably also possible to use gaseous blowing agents in pressurized cans, useful examples of which include all gases suitable for the purpose under pressure or in pressure-liquefied form, for example hydrocarbons such as butane isomers and propane isomers, dimethyl ether, nitrogen, air and other suitable gases.

Chemical blowing agents used may preferably be one or more compounds that react with NCO groups with the release of gases, for example water or formic acid, or which release gases during the reaction as a result of the rise in temperature, for example sodium hydrogencarbonate.

Optional additives (g) used may be one or more of the substances which are known from the prior art and are used in the production of polyurethanes, especially PU foams, for example crosslinkers, chain extenders, stabilizers against oxidative degradation (known as antioxidants), flame retardants, biocides, cell-refining additives, nucleating agents, further cell openers, solid fillers, antistatic additives, thickeners, dyes, pigments, colour pastes, fragrances, and/or emulsifiers etc.

As optional flame retardant, the composition according to the invention may contain one or more of the known flame retardants suitable for production of PU foams, for example halogen-containing or halogen-free organic phosphorus-containing compounds, for example triethyl phosphate (TEP), tris(1-chloro-2-propyl) phosphate (TCPP), tris(2-chloroethyl) phosphate (TCEP), dimethyl methanephosphonate (DMMP), dimethyl propanephosphonate (DMPP), ammonium polyphosphate or red phosphorus, chloroparaffins, nitrogen-containing compounds, for example melamine, melamine cyanurate or melamine polyphosphate, or halogenated compounds, for example chlorinated and/or brominated polyether polyols and/or polyester polyols. It is also possible to use mixtures of different flame retardants.

Unless the opposite is apparent from this description, it is possible to combine any preferred or particularly preferred embodiment of the invention with one or more of the other preferred or particularly preferred embodiments of the invention.

The process for producing PU foams can be conducted by any known methods, for example by manual mixing or preferably by means of foaming machines. If the process is conducted using foaming machines, it is possible to use high-pressure or low-pressure machines. The process for producing PU foams can be carried out either batchwise or continuously and it is possible for example to use 1K, 1.5K or 2K systems as described in EP 3717538 A1, U.S. Pat. No. 7,776,934 B2, EP 1400547 B1 or EP 2780384 B2.

One-component canned PU foam is well known to the person skilled in the art from the prior art. The term “one-component canned PU foam” in the context of the entire present invention encompasses polyurethane foams that are preferably characterized by the presence of a polyol-isocyanate prepolymer that can be blown from a pressurized can by gases as blowing agents and hence foamed.

Suitable polymers that are preferred for this purpose are obtainable, for example, by reacting polyols and (poly) isocyanates with one another by means of suitable catalysts (for example blowing catalysts such as 2,2′-dimorpholinyldiethyl ether) or else without catalyst action. The final curing of these prepolymers is then effected under the action of moisture, for example from the environment. Fields of use for this type of foam are the assembly, bonding and sealing of windows, door frames, pipes, bushings etc., and the filling of gaps in brickwork, cavities, cracks and joins.

Spray foam is a free-risen foam which is applied to a substrate by spraying of the liquid reaction components onto a substrate. Processing is generally effected by a spray foam machine, which may be implemented as a high- or low-pressure machine and combines and mixes the two components (polyol mixture and (poly) isocyanate). The foam is typically discharged by means of a static mixer in the form of a spray gun. In principle, the raw materials or foam may alternatively be discharged by gas pressure from a larger vessel, similarly to the principle of canned foams. The foam serves for insulation purposes and for structural purposes in walls, roofs, floors, and may be open-cell or closed-cell depending on the application.

Packaging foam serves for packaging, protection and cushioning of sensitive goods. It is usual to use a low-density open-cell foam that is intended to tightly enclose the goods to be protected and protect them from damage, impacts etc. For this purpose, the foam is optionally also foamed directly into the interspace between packaging and goods.

Thermoformable rigid polyurethane foams are rigid polyurethane foams that are mechanically deformed after production, for example by the application of heat, water/steam and pressure. The foam, which is in block form at first and is optionally cut to size, is used to produce a shaped article. Examples are headliner foam and hoodliner foam (foam for tailgates and cladding).

Floral foam, which is used, for example, for the arrangement of flowers etc., is a polyurethane foam which, by virtue of a low density, mechanical properties and high open-cell content, is suitable for accommodating flowers and further objects by insertion into the foam.

Pipe insulation foam is a polyurethane foam which is used for insulation of pipes. It first protects the pipe or pipe contents from losses of heat or refrigeration, and secondly from mechanical influences. Especially in the field of pipes laid in water bodies, at sea and in the deep ocean, a high open-cell content is desirable in some cases for mechanical reasons.

The SiOC-bonded, linear polydialkylsiloxane-polyether block copolymers having repeating (AB) units are preferably usable as interface-active additives, especially as some openers, especially also in all other PU foam, especially rigid PU foam, applications in which a high open-cell content is desirable, which has a direct positive effect, for example, on the dimensional stability of the foam.

The measurement of the open-cell content/closed-cell content of a rigid polyurethane foam is a trivial matter to the person skilled in the art and may preferably take place according to DIN ISO 4590:2016-12, “Rigid cellular plastics-Determination of the volume percentage of open cells and of closed cells”, for example with a gas pycnometer.

“High open-cell content” in the context of this invention is considered to be an open-cell content of the PU foam, especially rigid PU foam, of preferably ≥30%, further preferably ≥50% and especially >70%, of the cells. A possible upper limit in the open-cell content may, for example, be 90% of the cells or, for example, 80% of the cells or, for example, 100% of the cells.

The dimensional stability of a one-component canned PU foam can preferably be measured by method TM 1004:2013 of the FEICA-Association of the European Adhesive & Sealant Industry (“Determination of the Dimensional Stability of an OCF Canister Foam”, Brussels, 19.02.2013).

### Experimental:

### Test Methods:

In the context of the present invention, parameters or measurements are preferably determined using the methods described herein below. In particular, these methods were used in the examples of the present intellectual property right.

The SiH conversion of the dehydrogenative coupling is determined by butoxide-catalyzed liberation of the (residual) Si—H present in the sample as elementary hydrogen and quantitative determination thereof. In order to determine an SiH value, a defined amount of the sample to be analysed (between 0.3 and 10 g of sample according to the expected SiH value) is weighed into a reaction vessel containing a magnetic stirrer bar on an analytical balance. The reaction vessel is provided with a dropping funnel filled with about 25 ml of the sodium butoxide solution (5% in n-butanol). The reaction vessel is connected via a ground-glass joint with a three-way tap to a 50 ml water-filled burette, which is in turn provided with a water-filled balancing vessel via a hose. The reaction vessel stands on a magnetic stirrer plate at about eye level. The 3-way tap should be set at the start of the analysis such that all three pathways are open. The balancing vessel is taken from its holder and moved toward the burette. The aim is to bring the two liquid levels (burette & balancing vessel) into line at zero. Once this is the case, the 3-way tap is set such that only the pathway between the burette and reaction vessel is open. After a wait time of 60 seconds, in order to check the integrity of the apparatus, the liquid levels are again brought into line at zero. In the event of a leak, the ground-glass joints should be checked and regreased if necessary in order to create an apparatus with no leaks. If a leak has been found and remedied, the balancing of levels at zero should be conducted again. If the test setup has no leaks, the magnetic stirrer is set at a low stirring speed and the butoxide solution is added dropwise such that there is no break in the falling water column in the burette. From time to time, the liquid surfaces are again brought into line. Once the displaced liquid volume remains stable, i.e. the volume is unchanged with the liquid levels in line, the volume attained is recorded as the maximum gas volume released. Taking account of the water vapour pressure according to Landolt-Bornstein, the SiH value can be calculated according to the amount weighed out and using the general gas equation.

In the context of the present invention, weight-average and number-average molecular weights are determined for the produced SiOC-bonded, linear polydialkylsiloxane-polyoxyalkylene block copolymers and for the linear α,ω—(SiH)-functional polyalkylsiloxanes used with calibration against a polystyrene standard by gel permeation chromatography (GPC). In the following examples the polydispersity index (PDI) is reported as a further characteristic parameter for describing molecular weight distribution. GPC was performed using a PSS SECurity 1260(Agilent 1260) fitted with an RI detector and an SDV 1000/10000 Å column combination consisting of an 0.8×5 cm pre-column and two 0.8×30 cm main columns at a temperature of 30 °C and a flow rate of 1 mL/min (mobile phase: THF). The sample concentration was 10 g/l and the injection volume was 20 μl.

Wet chemistry analysis was performed according to international standard methods: iodine value (IV; DGF C—V 11 a (53); acid value (AV; DGF C—V 2); OH value (OHV; ASTM D 4274 C).

### Description of a Preferred Method of Controlling Hydrogen Evolution

It is a feature of the process according to the invention that the two reactants (a) and (b) are reacted preferably in equimolar amounts and with controlled evolution of hydrogen until SiH conversion is quantitative, in particular by metered addition of reactant (a) to an initial charge of reactant (b). What is especially envisaged by the term “controlled evolution of hydrogen” is that the rate of addition of the component (a) to (b) is such that the difference variance the actual conversion and the target conversion is preferably in the range from 0% to 10%, preferably from 0% to 7.5% and more preferably from 0% to 5%.

A preferred method of controlling the evolution of hydrogen is as follows:

The reaction is performed in a 1000 ml ground-glass four-necked flask fitted with a stainless steel Sigma stirrer®, internal thermometer and a reflux cooler with a gas discharge hose. The heating medium is a standard heating mantle controlled with a PID Fuzzy Logic to establish the target temperature. The siloxane to be added (=component (a)) is sucked in using a peristaltic pump via a reservoir vessel placed on a tared balance and transferred into the ground glass flask.

The gas discharge hose of the ground glass flask passes via a transition piece with an olive into a gas-tightly sealed 4 litre 2-necked flask which is filled with boiled gas-free water with zero dead volume. The 2-necked flask is further provided with a gas inlet tube with an olive which extends to just above the column bottom. The 2-necked flask is placed on a tared balance.

Starting the siloxane addition immediately causes the reaction to set in and the resulting gas which generates a volume expansion in the overall system is transferred into the two-necked flask. This in turn has the result that the water content is expelled from the flask via the inlet tube and is collected in a further collection vessel.

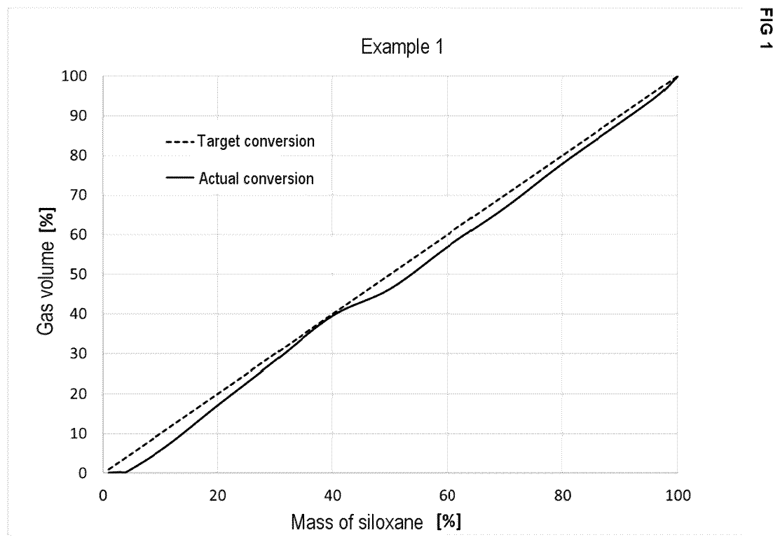

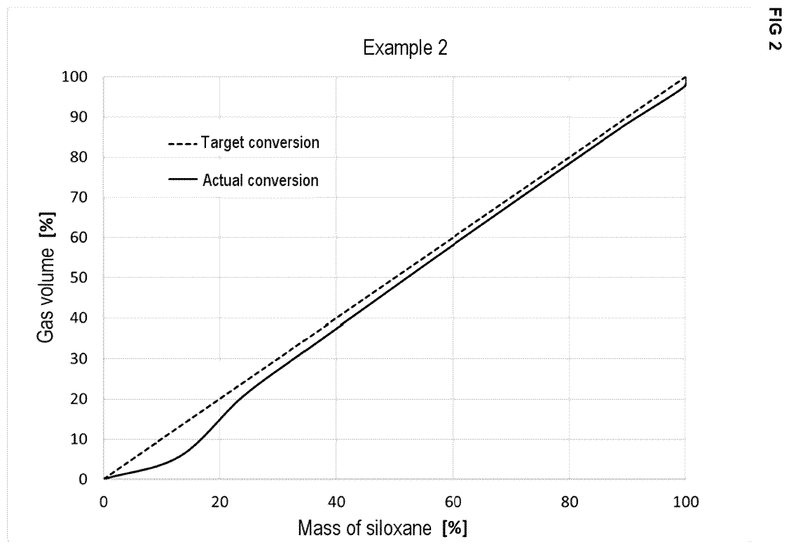

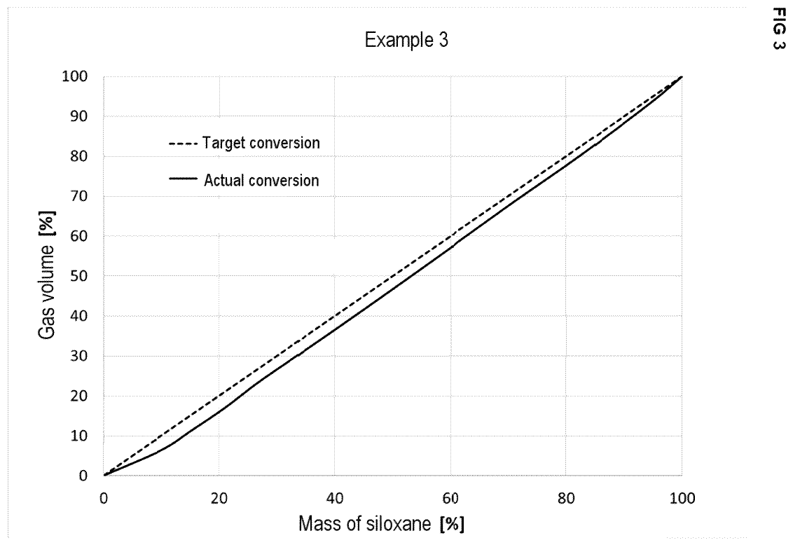

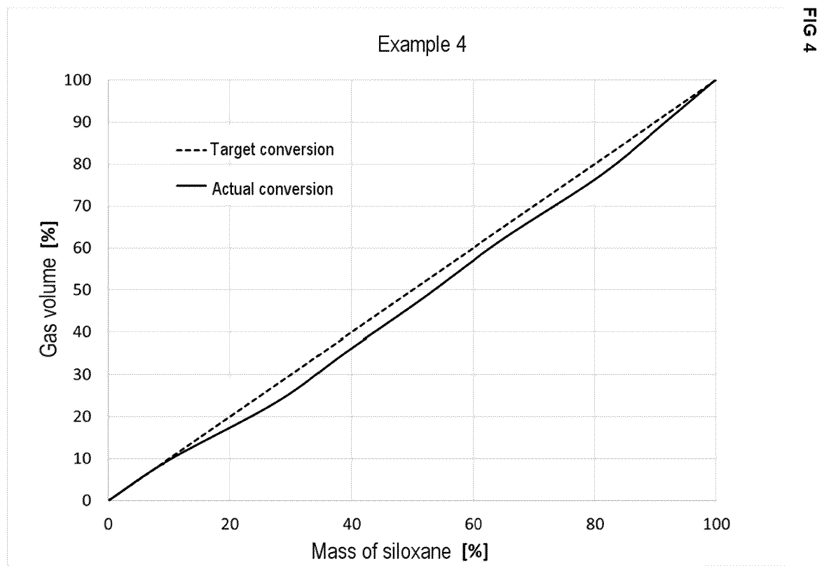

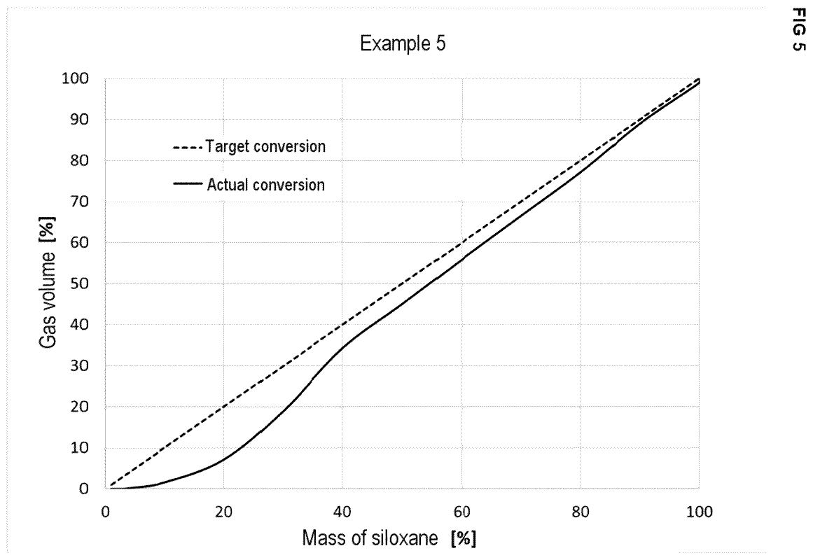

Continuous data capture of the individual masses via differential weighing of the siloxane and of the 2-necked flask makes it possible to identify the rate of reaction of the two reactants (a) and (b) to afford the product. This is done by plotting data pairs of the masses of the siloxane reservoir flask and of the 2-necked flask. The mass of the added siloxane may be used to calculate the theoretical gas volume that would occupied by the liberated hydrogen (byproduct) of the condensation reaction at this time. The target conversion of the respective reaction system may therefore be calculated over the entire course of the reaction. This is shown as a dashed line in FIGS. 1 to 5.

Using the mass of the displaced water with the aid of the density of the water at a particular temperature the actual evolved gas volume may be determined. The gas volume is calculated using the gas laws for ideal gases converted to standard conditions. The actual conversion of the respective reaction system may therefore be determined over the entire course of the reaction. This is shown as a solid line in FIGS. 1 to 5.

The quotient of actually evolved gas volume and theoretical gas volume describes the degree of conversion of the reaction at this time.

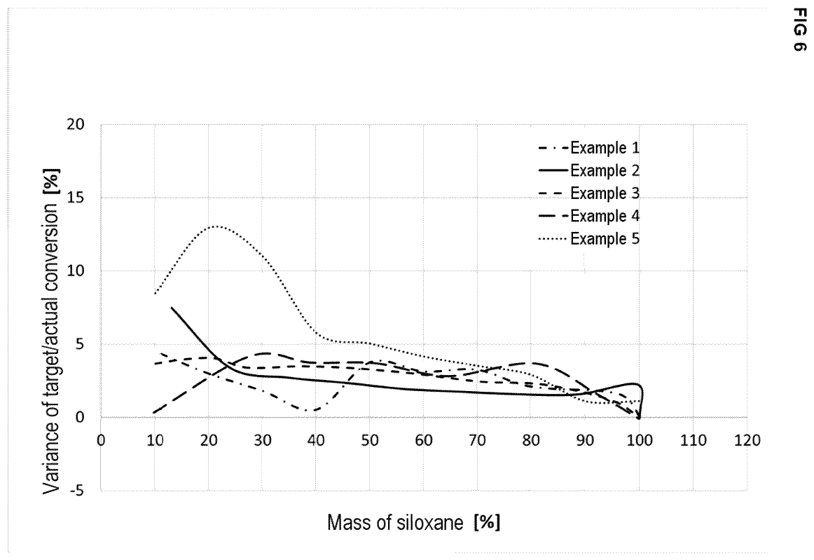

As apparent from the following inventive examples and the figure FIG. 6, it is very particularly preferred according to the invention when the rate of siloxane addition is chosen such that the difference between the “actual conversion” and the “target conversion” is preferably in the range from 0% to 10%, preferably from 0% to 7.5% and more preferably from 0% to 5%. This provision is applicable above a siloxane addition amount of 10% of the total amount to be added and more preferably above 5% of the total amount to be added. In this way, the person skilled in the art will be able, by simple manual experiments, to rapidly establish an optimal rate of siloxane addition and hence to achieve optimally controlled evolution of hydrogen.

### Example 1(According to the Invention)

A 1000 ml ground glass four-necked flask provided with a stainless steel Sigma stirrer, an addition unit with a peristaltic pump, an internal thermometer and a reflux cooler with a gas discharge hose is initially charged with 115.8 g of a dried polyoxyalkylene diol having a water content of <0.02%. The polyoxyalkylene diol having a weight-average molar mass of 2800 g/mol and an ethylene oxide/propylene oxide ratio of about 1:1 is combined with 198.0 g of a linear alkylbenzene having a boiling range of about 240 °C to 314 °C. The mixture is heated to a temperature of 105 °C. Then 123.0 mg of tris(pentafluorophenyl)borane (600 ppm based on the total amount of the reactants) dissolved in 20 g of the above-described alkylbenzene is added. After a stirring time of 5 minutes, 180.0 g of a 1:1 mixture of α,ω-hydrogensiloxane (average chain length N=30) and the above-described alkylbenzene is added in an equimolar ratio to the polyoxyalkylene diol used. The amount added and rate of addition are adjusted using a programmable peristaltic pump such that the total amount of the hydrogensiloxane is divided into about 18 individual intervals of 10 g each. The actual addition period of 2 minutes is immediately followed by a pause in addition of 10 minutes. This procedure is repeated in the same way for all 18 intervals. After addition of the stoichiometric siloxane amount a marked viscosity increase is observed. The end of the reaction is unambiguously discernible from the weakening gas evolution. Gas-volumetric SiH determination demonstrates complete conversion. A colorless high-viscosity product having a viscosity of 41 950 mPa s and a weight-average molecular weight of Mw of 171 400 g/mol and a PDI of 3.214 is obtained.

### Example 2(According to the Invention)

A 1000 ml ground glass four-necked flask provided with a stainless steel Sigma stirrer, an addition unit with a peristaltic pump, an internal thermometer and a reflux cooler with a gas discharge hose is initially charged with 210.9 g of a dried polyoxyalkylene diol having a water content of <0.02%. The polyoxyalkylene diol having a weight-average molar mass of 2800 g/mol and an ethylene oxide/propylene oxide ratio of about 1:1 is combined with 536.4 g of a linear alkylbenzene having a boiling range of about 240 °C to 314 °C. The mixture is heated to a temperature of 105 °C. Then 260.0 mg of tris(pentafluorophenyl)borane (700 ppm based on the total amount of the reactants) dissolved in 20 g of the above-described alkylbenzene is added. After a stirring time of 5 minutes, 160.0 g of a α,ω-hydrogensiloxane (average chain length N=30) is added in an equimolar ratio to the polyoxyalkylene diol used. The addition amount and rate is adjusted using a programmable peristaltic pump such that the total amount of the hydrogensiloxane is added continuously over 120 minutes. After addition of the stoichiometric siloxane amount a marked viscosity increase is observed. The end of the reaction is unambiguously discernible from the weakening gas evolution. Gas-volumetric SiH determination demonstrates complete conversion. A colorless high-viscosity product having a viscosity of 8786 mPa s and a weight-average molecular weight of Mw of 101 800 g/mol and a PDI of 2.465 is obtained.

### Example 3(According to the Invention)

A 1000 ml ground glass four-necked flask provided with a stainless steel Sigma stirrer, an addition unit with a peristaltic pump, an internal thermometer and a reflux cooler with a gas discharge hose is initially charged with 135.4 g of a dried polyoxyalkylene diol having a water content of <0.02%. The polyoxyalkylene diol having a weight-average molar mass of 2800 g/mol and an ethylene oxide/propylene oxide ratio of about 1:1 is combined with 234.4 g of a linear alkylbenzene having a boiling range of about 240 °C to 314 °C. The mixture is heated to a temperature of 105 °C. Then of 167.0 mg tris(pentafluorophenyl)borane (700 ppm based on the total amount of the reactants) dissolved in 20 g of the above-described alkylbenzene is added. After a stirring time of 5 minutes, 205.4 g of a 1:1 mixture of α,ω-hydrogensiloxane (average chain length N=30) and the above-described alkylbenzene is added in an equimolar ratio to the polyoxyalkylene diol used. The amount added and rate of addition are adjusted using a programmable peristaltic pump such that the total amount of the hydrogensiloxane is divided into about 18 individual intervals of 11.4 g each. The actual addition period of 2 minutes is immediately followed by a pause in addition of 15 minutes. This procedure is repeated in the same way for all 18 intervals. After addition of the stoichiometric siloxane amount a marked viscosity increase is observed. The end of the reaction is unambiguously discernible from the weakening gas evolution. Gas-volumetric SiH determination demonstrates complete conversion. A colorless high-viscosity product having a viscosity of 6197 mPa s and a weight-average molecular weight of Mw of 91 212 g/mol and a PDI of 2.341 is obtained.

### Example 4(According to the Invention)

A 1000 ml ground glass four-necked flask provided with a stainless steel Sigma stirrer, an addition unit with a peristaltic pump, an internal thermometer and a reflux cooler with a gas discharge hose is initially charged with 160.9 g of a dried polyoxyalkylene diol having a water content of <0.02%. The polyoxyalkylene diol having a weight-average molar mass of 2800 g/mol and an ethylene oxide/propylene oxide ratio of about 1:1 is combined with 410.6 g of a linear alkylbenzene having a boiling range of about 240 °C to 314 °C. The mixture is heated to a temperature of 105 °C. Then 201.0 mg of tris(pentafluorophenyl)borane (700 ppm based on the total amount of the reactants) dissolved in 20 g of the above-described alkylbenzene is added. After a stirring time of 5 minutes, 160.0 g of a α,ω-hydrogensiloxane (average chain length N=30) is added in an equimolar ratio to the polyoxyalkylene diol used. The addition amount and rate is adjusted using a programmable peristaltic pump such that the total amount of the hydrogensiloxane is added continuously over 221 minutes. After addition of the stoichiometric siloxane amount a marked viscosity increase is observed. The end of the reaction is unambiguously discernible from the weakening gas evolution. Gas-volumetric SiH determination demonstrates complete conversion. A colorless high-viscosity product having a viscosity of 60210 mPa s and a weight-average molecular weight of Mw of 173 600 g/mol and a PDI of 3.095 is obtained.

### Example 5(not According to the Invention)

A 1000 ml ground glass four-necked flask provided with a stainless steel Sigma stirrer, an addition unit with a peristaltic pump, an internal thermometer and a reflux cooler with a gas discharge hose is initially charged with 115.8 g of a dried polyoxyalkylene diol having a water content of <0.02%. The polyoxyalkylene diol having a weight-average molar mass of 2800 g/mol and an ethylene oxide/propylene oxide ratio of about 1:1 is combined with 198.0 g of a linear alkylbenzene having a boiling range of about 240 °C to 314 °C. The mixture is heated to a temperature of 105 °C. Then 123.0 mg of tris(pentafluorophenyl)borane (600 ppm based on the total amount of the reactants) dissolved in 20 g of the above-described alkylbenzene is added. After a stirring time of 5 minutes, 180 g of a 1:1 mixture of α,ω-hydrogensiloxane (average chain length N=30) and the above-described alkylbenzene is added in an equimolar ratio to the polyoxyalkylene diol used. The addition amount and rate is adjusted using a programmable peristaltic pump such that the total amount of the hydrogensiloxane is added continuously over 17 minutes. After addition of the stoichiometric siloxane amount a marked viscosity increase is observed. The end of the reaction is unambiguously discernible from the weakening gas evolution. Gas-volumetric SiH determination demonstrates complete conversion. A colorless high-viscosity product having a viscosity of 13780 mPa*s and a weight-average molecular weight of Mw Of 145 100 g/mol and a PDI of 2.689 is obtained.

### Drawings FIG. 1 to FIG. 6

The drawings FIG. 1 to FIG. 6 illustrate Examples 1 to 5 of the invention. The drawings FIG. 1 to FIG. 5 each show the volume of hydrogen liberated as a function of the amount of hydrogensiloxane added for Examples 1 to 5. The experiments differ in terms of the manner of addition (continuous or interval) and/or the rate of addition as described hereinabove.

The dashed line in each case indicates the target conversion. The solid line in each case indicates the actual conversion.

FIG. 6 shows a summary of the influence of reaction management on the difference between target and actual conversion as a function of added siloxane mass for the examples 1 to 5.

### Examples of the Use of the SiOC-Bonded, Linear Polydialkylsiloxane-Polyether Block Copolymers as Soil Openers in Polyurethane Formulations

The SiOC-bonded, linear polydialkylsiloxane-polyether block copolymers that have been obtained in the aforementioned inventive (Ex. 1-4) and non-inventive (Ex. 5) examples were used as cell openers.

Rigid polyurethane foams were produced using the following raw materials:
Rokopol® G 1000: polyether polyol from Rokita
Rokopol® D 1002: polyether polyol from Rokita
Desmophen® DE 10WF 15: polyether polyol from Covestro
Voranol® CP 3322: polyether polyol from Dow
PEG 600: polyethylene glycol
Stabilizer: TEGOSTAB® stabilizers from Evonik Operations GmbH,
TEGOSTAB® B 84728(one-component canned PU foam)
TEGOSTAB® B 8870(packaging foam)
TCPP: tris(2-chloroisopropyl) phosphate from Fyrol (flame retardant)
DABCO® DMDEE, from Evonik Operations GmbH, amine-based catalyst
Dimethyl ether
Propane
n-Butane
Isobutane
MDI: Desmodur® 44V20L from Covestro, diphenylmethane 4,4′-diisocyanate (MDI) with isomeric and higher-functionality homologues

### Production of Polyurethane Foams:

For testing in a one-component canned PU foam, all components of the formulation (see Table 1) except for the blowing agent were introduced into empty aerosol cans. Subsequently, the cans were sealed with their corresponding valves and, lastly, the defined amount of blowing agent (LPG, DME) was metered in by means of pressurized gas burettes.

The cans are then shaken manually for 1 min and then rotated in a rotary mixer for 30 min, so as to give a homogeneous mixture and to be able to form a homogeneous prepolymer.

For testing of the pore structure or internal defects, the contents of the can are discharged by means of a conventional foam gun after 24 h. This involves discharging a strand of foam onto paper and assessing the foam quality after the foam has cured visually on a scale from 1 to 10 after 24 h. For this purpose, the foam is cut in the middle. The value of 10 here represents a perfect foam without internal defects or an extremely fine cell; the number 1, by contrast, represents a collapsed foam or extremely coarse cell.

In order to determine the dimensional stability of a one-component canned PU foam with regard to propensity to shrinkage for expansion characteristics, the dimensional stability test (DMS test) according to method TM 1004:2013 of the FEICA-Association of the European Adhesive & Sealant Industry (“Determination of the Dimensional Stability of an OCF Canister Foam”, Brussels, 19.02.2013) was employed. For this purpose, two wooden panels were immersed in water for 30 s in order to allow the substrate to absorb a defined amount of water. Prior to the application of the foam, the foam cans are manually shaken for 1 min, and an initial fraction of the contents of the can (actuating the spray gun for about 3-5 seconds) was first discarded. Subsequently, 15 g of foam is applied between the wooden panels. The wooden panels are fixed with spacers and wooden clamps such that they have a constant distance of 2 cm from one another. After 24 h, spacers and wooden clamps are removed and a slide rule is used to ascertain the width between the two wooden panels. The measurement of width is repeated after 2, 3, 7 and 14 days, and the percentage variance by comparison with the 2 cm as starting point is ascertained and noted. In this context, minimum shrinkage or post-expansion is desirable, which correlates with a high open-cell content of the foam.

Testing was effected by the manual mixing method in the case of the packaging foam formulation. To this end, all components as per the formulation in Table 2 except for the polyisocyanate (MDI) were weighed out in a beaker and mixed by means of a disc stirrer (diameter 6 cm) at 1000 rpm for 30 s. Subsequently, the polyisocyanate (MDI) was added, and the reaction mixture was stirred with the stirrer described at 3000 rpm for 5 s and then applied into a box of footprint 27×27 cm². The foam moulding was demoulded after 10 minutes. After 24 h, the foam moulding is visually assessed with regard to shrinkage characteristics. Also after 24 h, a cut surface in the foam was used to visually assess the degree of internal defects and the pore structure on a scale from 1 to 10, where 10 represents an impeccable foam and 1 a very significantly defective foam.

TABLE 1
(formulation for one-component canned PU foam)

| Formulation of 1K canned foam | Weights [g] |
|---|---|
| Rokopol ® G 1000 | 81.4 |
| Rokopol ® P 1010 | 18.1 |
| DABCO ® DMDEE | 1.5 |
| Products from Ex. 1-5 | 0.5 |
| TEGOSTAB ® B 84728 stabilizer | 4.0 |
| TCPP | 54.7 |
| Dimethyl ether | 25.4 |
| Isopentane | 6.9 |
| n-Butane | 11.6 |
| Propane | 16.1 |
| MDI | 179.3 |

TABLE 2
(formulation for two-component canned PU foam)

| 2K packaging foam formulation | Weights [g] |
|---|---|
| Desmophen ® DE 10WF 15 | 20.0 |
| Voranol ® CP 3322 | 32.0 |
| PEG 600 | 5.0 |
| Products from Ex. 1-5 | 0.5 |
| TEGOSTAB ® B 8870 stabilizer | 1.5 |
| DABCO ® DMDEE | 2.5 |
| Water | 35.0 |
| MDI | 226.0 |

The results of the foaming tests in the one-component canned PU foam with the examples are summarized in Table 3. As described above, foam strands were produced and DMS tests were conducted. Internal defects or pore fineness was rated on a scale of 1-10. Dimensional stability (DMS) is reported in % shrinkage (negative values) or expansion (positive values) based on the original thickness of the foam. Measurements were affected after 1, 2, 3, 7 and 14 days.

TABLE 3
Results of the foaming tests in the one-component canned PU foam

| | Products | | | | | | | |
|---|---|---|---|---|---|---|---|---|
| | (cell | Dimensional stability (DMS) [%] | | | | | Pore | Internal |
| Foam | opener) | 1 d | 2 d | 3 d | 7 d | 14 d | structure | defects |
| Ex. 6 | Ex. 1 | 0.9 | 1.4 | 1.3 | 0.9 | 1.2 | 6.0 | 7.0 |
| Ex. 7 | Ex. 2 | 0.9 | 1.5 | 1.2 | 0.9 | −0.2 | 7.0 | 7.5 |
| Ex. 8 | Ex. 3 | 0.2 | 0.8 | 1.3 | 1.0 | 0.9 | 6.0 | 6.0 |
| Ex. 9 | Ex. 4 | 0.6 | 0.9 | 1.0 | 0.8 | 0.0 | 6.0 | 7.0 |
| Ex. 10 | Ex. 5 | −18.9 | −25.3 | −25.2 | −21.6 | −13.1 | 6.0 | 6.5 |
| non-inv. | non-inv. | | | | | | | |

It is clearly apparent from the experiments that the cell openers according to the invention (Ex. 1-4) achieve distinctly improved dimensional stability is compared to the noninventive product from Ex. 5. No adverse effect is observed here on pore structure and internal defects.

The results of the foaming tests in the packaging foam with the examples are summarized in Table 4. Internal defects and pore structures are rated on a scale of 1-10 analogously to the tests in the one-component canned PU foam.

TABLE 4
Results of the foaming tests in the two-component packaging foam

| | Products | Pore | Internal | Foam height | Visible |
|---|---|---|---|---|---|
| Foam | (cell opener) | structure | defects | [cm] | shrinkage |
| Ex. 11 | Ex. 4 | 6.0 | 8.0 | 38.0 | no |
| Ex. 12 | Ex. 5 | 4.0 | 5.0 | 38.0 | yes |
| non-inv. | non-inv. | | | | |

It is clearly apparent from the experiments that the cell opener according to the invention effectively prevents shrinkage without showing any adverse effect on pore structure and internal defects (Ex. 11). In non-inventive Ex. 12, slight shrinkage of the foam moulding after 24 h was apparent, which is caused by inadequate cell opening. At the same time, pore structure and internal defects are worsened compared to Ex. 11.

1-16. (canceled)

17. A process for producing SiOC-bonded, linear polydialkylsiloxane-polyoxyalkylene block copolymers comprising repeating (AB) units, comprising reacting:
a linear, α,ω—(SiH)-functional polydialkylsiloxane (a); with
a linear α,ω—(OH)-functional polyoxyalkylene (b);
using one or more compounds of elements of main group III and/or the 3rd transition group as catalyst (c);
optionally in the presence of a solvent (d).

18. The process of claim 17, wherein the two reactants (a) and (b) are reacted in equimolar amounts and with controlled evolution of hydrogen until SiH conversion is quantitative.

19. The process of claim 17, wherein the linear α,ω—(SiH)-functional polydialkylsiloxane has SiH values between 0.25 and 3.0 mol/kg.

20. The process of claim 19, wherein the linear α,ω—(SiH)-functional polydialkylsiloxane has SiH values between 0.75 and 1.5 mol/kg.

21. The process of claim 17, wherein the linear α,ω—(SiH)-functional polydialkylsiloxane conforms to the general formula (I):
M′-Dₐ-M′ Formula (I)
wherein:
M′=[HR₂¹SiO_{1/2}];
D=[R₂¹SiO_{2/2}];
a=8-100;
R¹=independently at each occurrence, identical or different hydrocarbon radicals having 1-20 carbon atoms.

22. The process of claim 21, wherein:
a=20-50; and
R¹=methyl, ethyl, propyl or butyl.

23. The process of claim 17, wherein the linear α,ω—(OH)-functional polyoxyalkylene conforms to the formula (II):
HO—(CₙH₍₂ₙ₋ₘ₎R²ₘO—)_{b}-H Formula (II)
wherein:
b=1-200;
n=2-4;
m=0 or 1;
R²=independently at each occurrence, identical or different hydrocarbon radicals having 1-12 carbon atoms.

24. The process of claim 23, wherein:
b=25-60; and
R¹=methyl, ethyl, propyl or butyl.

25. The process of claim 17, wherein the oxyalkylene units in the linear α,ω—(OH)-functional polyoxyalkylene comprise oxyethylene and/or oxypropylene units.

26. The process of claim 25, wherein the oxyalkylene units in the linear α,ω—(OH)-functional polyoxyalkylene comprise mixed oxyethylene and oxypropylene units having an oxyethylene proportion of 25% to 70% by weight.

27. The process of claim 17, wherein the molar ratio of the two reactants (a) to (b) is in the range from 0.9 to 1.10.

28. The process of claim 17, wherein the molar ratio of the two reactants (a) to (b) is in the range from 0.98 to 1.02.

29. The process of claim 17, wherein the reaction of the reactants (a) and (b) is carried out such that reactant (b) is initially charged and reactant (a) is added, wherein the addition is performed continuously or at intervals.

30. The process of claim 29, wherein the the addition of (a) and (b) is as follows:
(i) reactant (b) is heated to reaction temperature, catalyst is added and commixed and reactant (a) is then added with controlled evolution of hydrogen;
(ii) reactant (b) is heated to reaction temperature, catalyst is added and commixed and reactant (a), diluted with solvent, is then added with controlled evolution of hydrogen;
(iii) reactant (b) is heated to reaction temperature, diluted with solvent and the catalyst is added and commixed and reactant (a) is then added with controlled evolution of hydrogen; or
(iv) reactant (b) is heated to reaction temperature, diluted with solvent and the catalyst is added and commixed and reactant (a), diluted with solvent, is then added with controlled evolution of hydrogen.

31. The process of claim 17, wherein the reaction temperature for producing the SiOC-bonded, linear polydialkylsiloxane-polyoxyalkylene block copolymers having repeating (AB) units is in the range from 60 °C to 140 °C.

32. The process of claim 17, wherein the catalyst is used in amounts of 0.01% to 0.2% by weight based on the sum of the amount of reactants (a) and (b); and wherein (c) is a boron-containing and/or aluminium-containing catalyst and/or a scandium-containing, yttrium-containing, lanthanum-containing and/or lanthanoid-containing catalyst.

33. The process of claim 17, wherein evolution of hydrogen is controlled by adjusting the rate of addition of component (a) relative to (b) such that the variance in the actual conversion from the target conversion is from 0% to 10%.

34. The process of claim 33, wherein the variance in the actual conversion from the target conversion is from 0% to 5%.

35. SiOC-bonded, linear polydimethylsiloxane-polyether block copolymers comprising repeating (AB) units produced by the process of claim 17.

36. A polyurethane foam, produced using SiOC-bonded, linear polydialkylsiloxane-polyether block copolymers comprising repeating (AB) units according to claim 35.
